(19) United States
(12) Patent Application Publication
(10) Pub. No.: US 2017/0033363 A1
(43) Pub. Date: Feb. 2, 2017

(54) METHOD FOR PRODUCING AN ELECTRODE OF A LITHIUM-ION BATTERY

(71) Applicant: Robert Bosch GmbH, Stuttgart (DE)

(72) Inventors: Pallavi Verma, Leinfelden (DE); Andreas Netz, Ludwigsburg (DE); Silvan Hippchen, Sersheim (DE)

(21) Appl. No.: 15/223,800

(22) Filed: Jul. 29, 2016

(30) Foreign Application Priority Data
Jul. 31, 2015 (DE) 102015214577.8

(51) Int. Cl. H01M 4/62; H01M 4/587; H01M 4/58; H01M 4/36; H01M 4/1395; H01M 4/04; H01M 10/0562; H01M 4/66; H01M 10/0525; H01M 4/1393

(52) U.S. Cl. CPC H01M 4/628; H01M 10/0525; H01M 4/587; H01M 4/58; H01M 4/1393; H01M 4/1395; H01M 4/0435; H01M 10/0562; H01M 4/661; H01M 4/364; H01M 2220/20; H01M 2004/027

(57) ABSTRACT

A method for producing an electrode of a lithium-ion battery having the steps of providing a precursor including an electrode active material and LiF, of providing a metal foil and of joining the precursor and the metal foil. Furthermore, a method for producing a lithium-ion battery is provided as well as electrodes and lithium-ion batteries that are producible according to the method.

### CROSS REFERENCE

The present application claims the benefit under 35 U.S.C. §119 of German Patent Application No. DE 102015214577.8 filed on Jul. 31, 2015, which is expressly incorporated herein by reference in its entirety.

### FIELD

The present invention relates to a method for producing an electrode of a lithium-ion battery.

Furthermore, a method for producing a lithium-ion battery is provided as well as electrodes and lithium-ion batteries that are producible according to the method.

### BACKGROUND INFORMATION

In the following, the term “battery” is also used to designate accumulators, as in ordinary language usage. The term “cell” refers to “battery cells” or “accumulator cells.”

To achieve greater ranges in electric vehicles, new batteries using high-energy materials are required. Lithium-based battery cells are increasingly used for this purpose since these currently have the greatest available energy density at the lowest weight, in particular in comparison to batteries based on nickel or lead. Promising candidates for high-energy materials used in particular on the anode of the lithium batteries are in particular silicon and silicon composite material.

In the case of silicon as anode material, however, decomposition products from the electrolyte are deposited on the surface of the silicon in the course of a formation of battery cells, that is, their first electrochemical charging. This layer is also called an SEI layer (SEI, solid electrolyte interface). The SEI layer results in a loss in capacity since lithium from the active material and/or from the electrolyte is irreversibly chemically bound in these layers. The loss in capacity is also called a “first cycle loss” and may be up to 30%. The loss in capacity affects the performance of the electrode negatively.

German Patent Application Ne. DE 10 2011 109 134 A1 describes that intact electrochemical active material is reclaimed from old cells in order to reuse it in new cells so that expended cells may be recycled. For this purpose, a battery cell is presented, which has an electrode having electrochemical active material that was treated from the outside by specified measures, for example by renewing and/or newly developing the SEI layer. The specified measures may be: partial reduction of the SEI layer by mechanical force, partial removal of the SEI layer by use of a solvent or treatment of the active material using an SEI layer-forming substance having at least one electrolyte or an additive.

An object of the present invention is to provide electrodes and lithium-ion batteries in which the first cycle loss is reduced.

### SUMMARY

According to a first aspect, a method according to the present invention for producing an electrode of a lithium-ion battery includes:
(a) providing a precursor including an electrode active material and LiF,
(b) providing a metal foil and
(c) joining the precursor and the metal foil.

The electrode may be for example and preferably an anode of a lithium-ion battery. In connection with the present invention, the anode is also referred to as the negative electrode. When connected to a load, for example an electric motor, the anode gives off electrons.

The anode may be made from any material used in the production of lithium-ion anodes that forms an SEI layer in the formation. It has, for example, graphite as an anodically active material and a current collector made from copper. Anodically active material, however, may include any material that is able to give off electrons and produce an flow of ions, in particular e.g. lithium, magnesium, iron, nickel, aluminum, zinc or composites of these. Silicon, germanium, lithium, further carbon-containing material or amorphous carbons or a metal alloy are also advantageous as anodically active material. Hybrid electrodes having lithium alloy components are also common. As is known, conductivity additives and binding agents may be added to the electrode.

According to a particularly preferred specific embodiment, the electrode active material of the anode contains silicon or a composite material including silicon and carbon.

When connected to a load, for example an electric motor, the cathode of a lithium-ion battery takes up electrons. In connection with the present invention, the cathode is also referred to as the positive electrode. The cathode may be made from any material for producing lithium-ion cathodes. The cathode has for example lithium cobalt dioxide (LiCoO2) as cathodically active material and a current collector made from aluminum. Oxidic materials, in particular lithium cobalt dioxide (LiCoO2), lithium iron phosphate (LiFePO4), spinel lithium manganese oxide (LiMn2O4) or mixed oxides including nickel are particularly suitable as cathodically active material. Nickel/manganese/cobalt/aluminum mixed oxides, lithium-metal phosphates, lithium manganese spinels or sulfur as well as sulfur compounds are also used. Any mixtures thereof are possible and in use.

Preferably, in the method of the present invention, first a dry mass is provided in step (a), which contains at least the electrode active material and LiF. The dry mass is processed to form the precursor. The processing of the dry mass into the precursor preferably occurs by laminating the dry mass using a first sheeting calendar.

In step (c) of the method of the present invention, preferably a lamination is performed of the precursor and the metal foil using a second sheeting calendar.

According to a further aspect of the present invention, a method for producing a lithium-ion battery includes a first step, in which one of the methods described herein for producing the electrode of the lithium-ion battery is carried out, a second step of the further processing of the electrode together with a counter-electrode and an electrolyte to produce the lithium-ion battery, and a third step of a formation of the lithium-ion battery, in which an SEI layer (solid electrolyte interface) forms at least partially by accumulation of the LiF processed in the electrode.

According to another aspect of the present invention, an electrode of a lithium-ion battery is indicated, which is producible or was produced according to one of the previously described methods.

According to another aspect of the present invention, a lithium-ion battery according to the invention has one of the electrodes described herein.

According to another aspect of the present invention, a lithium-ion battery is indicated, which is producible or was produced according to one of the previously described methods.

The lithium-ion battery preferably has a first cycle loss of less than 30%, particularly preferably of less than 10% and even more preferably of less than 5%.

The mode of functioning of the lithium battery cell of the present invention is based on a source voltage arising as a consequence of the different electrochemical potentials of the lithium in the two electrodes. In the course of the cell reaction, lithium ions are shifted from the one electrode into the other electrode. In the charging process, positively charged lithium ions (Li+ions) travel through the electrolyte from the positive electrode into the anodically active material of the negative electrode, while a charge current delivers the electrons via the external wiring. In the case of silicon as an anodically active material, lithium ions form with the silicon an Li₄Si alloy. In a discharge process, the lithium ions travel back into the cathodically active material, and the electrons are able to flow via the external wiring to the positive electrode.

The use of a precursor in accordance with the present invention, which contains the LiF, avoids the irreversible depletion and loss of the lithium from the electrolyte and/or from the active material of the cell in the formation. The methods and devices of the present invention are able greatly to reduce or even avoid the first cycle loss. For this reason, the lithium-ion battery is especially suitable for use in electric vehicles.

One preferred specific embodiment of the present invention takes the form of a silicon electrode. In contrast to alternative electrodes, the surface layer on the silicon particles is more homogeneous in the silicon electrode of the present invention. The surface layer on the silicon particles of the electrode of the present invention contains a higher percentage by weight of LiF and less of other components than in alternative electrodes in which the LiF stems from the decomposition of the electrolyte.

### BRIEF DESCRIPTION OF THE DRAWINGS

Exemplary embodiments of the present invention are illustrated in the figures and are explained in greater detail below.

FIG. 1 shows a lateral view of a first sheeting calendar.

FIG. 2 shows a lateral view of a second sheeting calendar.

FIG. 3 shows a schematic representation of a production method of a lithium-ion battery.

### DETAILED DESCRIPTION OF EXAMPLE EMBODIMENTS

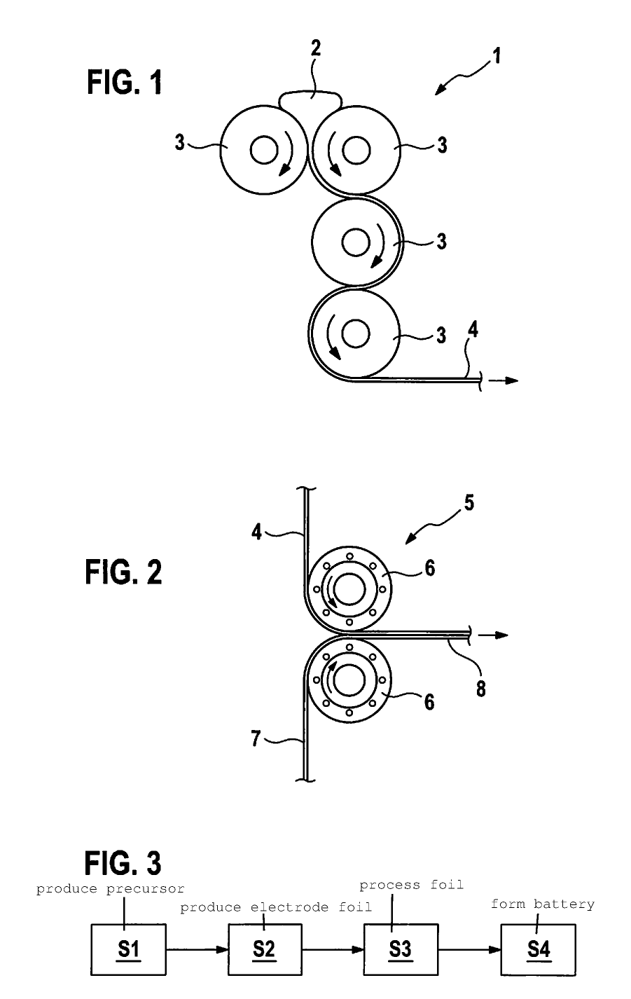

FIG. 1 schematically shows a first sheeting calendar 1 in a lateral sectional view.

Sheeting calendar 1 here includes for example four calendar rolls 3, which are situated with respect to one another in such a way that a dry mass 2 may be processed into a self-supporting electrode foil, which is called a precursor 4 in connection with the present invention. Precursor 4, which leaves first sheeting calendar 1, may be described as self-supporting due to its rigidity.

For this purpose, dry mass 2 is first processed into a foil with the aid of two heated calendar rolls 3. The additional two calendar rolls 3 shown are used for further compression and deflection of precursor 4.

The method shown in FIG. 1 is also called a dry coating of the electrode active material with LiF. The dry coating is a solvent-free method for producing precursor 4.

Dry mass 2 includes for example silicon or a silicon-carbon composite as the electrode active material as well as binding agents and conductivity additives, which are able to form a dry premix. Dry mass 2 furthermore includes the chemical material LiF, which may have been admixed to the dry premix. The LiF in this instance is present as salt. Under the pressure and the temperature of calendar rolls 3, the binding agent forms a fibrilla-like network that ensures the mechanical stability of precursor 4.

FIG. 2 shows the further processing of precursor 4 by a second sheeting calendar 5 schematically in a lateral sectional view.

Second sheeting calendar 5 here includes by way of example two additional calendar rolls 6, which are situated at a defined distance with respect to each other. Precursor 4 is fed into second sheeting calendar 5 from a first direction, it being possible for precursor 4 to have been produced for example using the first sheeting calendar 1 shown in and described with respect to FIG. 1. A metal foil 7, for example an aluminum foil or a copper foil, are fed into second sheeting calendar 5 from a second direction. Precursor 4 and metal foil 7 are joined between the two additional calendar rolls 6, in particular laminated for example. An electrode foil 8 leaves the second sheeting calendar 5 on the output side.

FIG. 3 shows a production method according to the present invention of a lithium-ion battery in a schematic representation.

A method for producing an electrode as described with reference to FIGS. 1 and 2 is carried out in two steps S1 and S2. In first step S1, a precursor 4 is produced as shown in FIG. 1, and in the second step S2, an electrode foil 8 is produced as shown in FIG. 2.

In a third step S3, electrode foil 8 is processed further for use in a battery cell, typically cut and wound and processed further together with a corresponding counter-electrode and an electrolyte to form the lithium-ion battery.

The fourth step S4 comprises a formation of the lithium-ion battery, which may also be called a conditioning. In the formation, an SEI layer is formed at least partially by the accretion of the LiF processed in the electrode. In this manner, the first cycle loss is avoided. The irreversible loss of lithium is thus avoided in the formation.

In the event that silicon is used as the anode material, a surface layer forms on the silicon particles during the formation, particularly the LiF incorporated in the electrode being added in the process.

The present invention is not restricted to the exemplary embodiments described and the aspects emphasized herein. Rather, a multitude of variations are possible that lie within the scope of the actions of one skilled in the art.

What is claimed is:

1. A method for producing an electrode of a lithium-ion battery, comprising:
(a) providing a precursor including an electrode active material and LiF;
(b) providing a metal foil; and
(c) joining the precursor and the metal foil.

2. The method as recited in claim 1, wherein in step (a) first a dry mass is provided, which contains at least the electrode active material and LiF, and the dry mass is processed to form the precursor.

3. The method as recited in claim 2, wherein the processing of the dry mass into the precursor occurs by laminating the dry mass using a first sheeting calendar.

4. The method as recited in claim 1, wherein in step (c), the precursor and the metal foil are laminated by a second sheeting calendar.

5. A method for producing a lithium-ion battery, comprising:
producing an electrode of the lithium-ion battery by providing a precursor including an electrode active material and LiF, providing a metal foil, and joining the precursor and the metal foil;
processing the electrode together with a counter-electrode and an electrolyte to form the lithium-ion battery; and
carrying out a formation of the lithium-ion battery, in which an SEI layer is formed at least partially by accretion of the LiF processed in the electrode.

6. An electrode of a lithium-ion battery, the electrode being produced by providing a precursor including an electrode active material and LiF, providing a metal foil, and joining the precursor and the metal foil.

7. A lithium-ion battery which is produced by producing an electrode of the lithium-ion battery by providing a precursor including an electrode active material and LiF, providing a metal foil, and joining the precursor and the metal foil, processing the electrode together with a counter-electrode and an electrolyte to form the lithium-ion battery, and carrying out a formation of the lithium-ion battery, in which an SEI layer is formed at least partially by accretion of the LiF processed in the electrode.

8. The lithium-ion battery as recited in claim 7, wherein the battery has a formation loss of the capacity of less than 30%.

9. The lithium-ion battery as recited in claim 8, wherein the formation loss of the capacity is less than 5%.

10. The method as recited in claim 1, wherein the electrode active material contains silicon or a composite material including silicon and carbon.

11. The method as recited in claim 5, wherein the electrode active material contains silicon or a composite material including silicon and carbon.

12. The electrode as recited in claim 6, wherein the electrode active material contains silicon or a composite material including silicon and carbon.

13. The lithium-ion battery as recited in claim 7, wherein the electrode active material contains silicon or a composite material including silicon and carbon.

14. The method as recited in claim 1, wherein the electrode is an anode of the lithium-ion battery.

15. The method as recited in claim 5, wherein the electrode is an anode of the lithium-ion battery.

16. The electrode as recited in claim 6, wherein the electrode is an anode of the lithium-ion battery.

17. The lithium-ion battery as recited in claim 7, wherein the electrode is an anode of the lithium-ion battery.
